(19) United States
(12) Patent Application Publication
(10) Pub. No.: US 2010/0169364 A1
(43) Pub. Date: Jul. 1, 2010

(54) Metadata Enhanced Browser

(75) Inventor: Dick C. Hardt, Vancouver (CA)

Correspondence Address: PERLEY-ROBERTSON, HILL & MCDOUGALL LLP, 1400-340 Albert Street, OTTAWA, ON, K1R 0A5, CA

(73) Assignee: BLAME CANADA HOLDINGS INC., Vancouver, BC (CA)

(21) Appl. No.: 12/493,565

(22) Filed: Jun. 29, 2009

Related U.S. Application Data
(60) Provisional application No. 61/076,883, filed on Jun. 30, 2008.

(51) Int. Cl. G06F 7/10; G06F 17/30; G06F 3/01

(52) U.S. Cl. 707/769; 707/E17.108; 707/705; 715/760

(57) ABSTRACT

A social networking browser can display contextually relevant content to a user while the user navigates the Internet. The contextually relevant content is selected based on a determination of the topic of the displayed page, and can include contact-centric information about connections in the user's social graph.

### CROSS REFERENCE TO RELATED APPLICATION

This application claims the benefit of priority from U.S. Provisional Patent Application No. 61/076,883 filed Jun. 30, 2008, the contents of which are incorporated herein by reference.

### FIELD OF THE INVENTION

This invention relates generally to the presentation of metadata related to the content of a web page displayed by a browser.

### BACKGROUND OF THE INVENTION

As users navigate various Internet sites, they are presented with information. Each web browser accessible page has a level of content that is not at first apparent. The data provided on a page often has a relationship to the user that may not be apparent immediately. This data can be referred to as metadata; that is data about the data presented on the page. Often, metadata is defined by the content creator, such as IPTC data about a digital photograph. This data includes location information defining where the photo was taken, creator identification data, copyright data and other data elements selected by the content creator. This metadata can be used for a number of different purposes.

Other metadata may not be explicitly defined. Social networking sites provide information about people connected to the user. However, other data about the connected people is often not provided. This data is often relationship specific, and is contained in the so-called dark web that is not publicly accessible or on the user's machine. The social networking data is connected to the other relationship data through metadata that can be extracted from the viewing of the connected person's profile.

There have been very few attempts at providing a user with metadata about a webpage. Notable examples of such attempts include the Google™-toolbar, which can be configured to display the Google PageRank of a page as it is viewed, and the Alexa toolbar which provides traffic statistics about the page. The Google PageRank value is considered to be indicative of the relevance of a page, while the Alexa traffic statistics are considered a guide to the popularity of a page. This metadata is not intrinsic to the page, and can thus be considered a simple form of extrinsic metadata.

Extrinsic metadata includes information such as the relationship data discussed above as well as other data including other pages that are relevant to the topic of a page, and content that can bee assembled or extracted from external sources about the topic of the page. There is, at this time, no mechanism for a user to assemble useful extrinsic metadata about Internet derived content.

### SUMMARY OF THE INVENTION

It is an object of the present invention to obviate or mitigate at least one disadvantage of the prior art.

It is a further embodiment of the present invention to provide a method of selecting extrinsic metadata relevant to a user about a webpage comprising: receiving a webpage from an external server through a network interface; parsing the received webpage to identify cues indicating the topic of the webpage; selecting metadata from an extrinsic metadata store in accordance with the identified cues, at least a portion of the metadata in the extrinsic metadata store being specific to the user; and displaying the selected metadata to the user through a display interface.

It is still a further object of the present invention to provide a browser for displaying extrinsic metadata about a webpage, the browser comprising: a network interface for receiving webpages from external servers; a parsing engine for examining webpages received by the network interface and for identifying cues indicating the topic of the examined webpage; a metadata selector for selecting data from an extrinsic metadata store in accordance with the topic indicated by the cues identified by the parsing engine; and a display interface for transmitting the selected data to a user viewable display.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a screen capture of the present invention informing the user of the existence of extrinsic metadata about the topic of a web page;

FIG. 2 illustrates a screen capture of the present invention displaying the extrinsic metadata about the topic of the webpage in a sidebar;

FIG. 3 illustrates a screen capture of the present invention showing contact detail information in a collapsible pane in the sidebar;

FIG. 4 illustrates a screen capture of the present invention showing contact information in a collapsible pane in the sidebar;

FIG. 5 illustrates a screen capture of the present invention showing the contact information pane collapsed in the sidebar after being previously expanded;

FIG. 6 illustrates a screen capture of the present invention directing the web browser to a profile page in response to user input;

FIG. 7 illustrates a screen capture of the present invention facilitating the user to send a social networking message to a contact in response to user input;

FIG. 8 illustrates a screen capture of the present invention facilitating the user to connect to a contact over a social network on which no connection is present in response to user input;

FIG. 9 illustrates a screen capture of the present invention providing a chronological listing of contact based social information;

FIG. 10 illustrates a screen capture of the present invention presenting a series of links to alternate websites as extrinsic metadata related to the topic of a webpage;

FIG. 11 illustrates in block diagram an exemplary method of the invention; and

FIG. 12 illustrates in block diagram an embodiment of a system of the invention.

### DETAILED DESCRIPTION

The present invention is directed to presenting users with relevant information selected based on extrinsic metadata about the content of pages received through the Internet.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

As noted above, when a user browses different Internet pages, only a small amount of the information available is presented to the user. There is a vast web of metadata that can be used to provide the user with a richer experience. This extrinsic information can be extracted from a webpage through the use of an enhanced web-browser which can be implemented as a plug-in or extension to an existing web browser or as a standalone web browser. Furthermore, the present invention can be extended to other information sources including connection based information such as electronic mail, and can be provided in the form of an enhancement to a mail reader.

In some embodiments, the present invention recognizes social networking sites and can provide extrinsic metadata about the pages of social networking sites that is tailored to the connection based content that they are designed for. The connection based content displayed to the user can be drawn from both public and dark data sources. Public data sources can include social networking sites and other publicly available sources of identity information, while private data sources can include address book information, email histories and other private information such as call logs, instant messaging histories and logs of SMS and MMS messages.

In the present invention, extrinsic metadata, relevant information to the user, about the pages that a user views is presented in a secondary viewing window, which may be a sidebar. The metadata is obtained from a number of different sources, including both publicly accessible information and dark data accessible to the user. The data that is presented can be selected from a larger set of metadata in accordance with user preferences and user profile information. The metadata can be viewed as being relevant to the topic of a page. If the topic is identified as being a person, the relevant extrinsic metadata can include information about how the person is connected to the user, what correspondence has been exchanged, and other such information. If the topic is identified as a place, the relevant extrinsic metadata can include transportation and accommodation options if the location is determined as being remote from the user. If the topic is identified as a product, reviews of the product and links to stores to allow purchasing of the product can be used as relevant metadata. Examples of some extrinsic metadata are discussed below, staring with an example of a page where the identified topic is a person.

When a user joins a social networking site, contacts are added, and a limited social graph is created. Every social network that the user joins enhances the social graph. Social graphing connections can be used to associate the profiles of a contact across different social networking sites. Thus, a user can connect to one person on more than one social network, and through the use of social graph data, along with other information, a programmatic determination can be made that profiles on different sites refer to the same contact. The social graph data can be supplemented by a programmatic comparison of the identity information available across all the social networking and identity information sources. For example, if two profiles on different social networks provide the same contact email address and the same name, they can be programmatically linked to each other as being the same person. The present invention builds a private social graph through the above described steps first by accessing the list of social networking contacts at each social networking site through use of the user's login (typically a username and password combination). This allows the present invention to obtain identifying information about the contacts. For profiles that do not self identify corresponding profiles on different social networks other identity information contained in the profiles, including names, addresses, email addresses and other unique identifiers can be used to link profiles together. The user can optionally be given the ability to verify that the links are valid. Users can also be given the ability to link two otherwise distinct profiles if the user knows the profiles are the same person. Each social networking site functions as a source of profile information, and is supplemented by other information. Users often had a great deal of information about their contacts spread across a number of different applications. Address book entries provide a wealth of information about contacts and often provide information not made available through social networking sites, similarly email correspondences (through locally stored email applications or web based email applications) provide a users with a context within which they relate to the connection, so do logs of instant messaging clients. Where a unified inbox of correspondence is available, short message service (SMS), multimedia messaging service (MMS) and telephone call logs can also be used to provide context related to a connection. Really Simple Syndication (RSS) feeds to a contact's web log, internet site, or to another resource associated with the contact are also useful content sources that can be accessed.

By creating a profile that links these data sources together, a user can be provided with a better view of how he is connected to a contact. It can also provide the user with a view of where the connections exist, and through what channels no connection is provided. Thus, a user who has joined a plurality of social networking sites can see how they are and are not connected to other users. The user can also see recent communications with the contact through email, IM, cellular phone as well as the current status of the contact, recent blog posts, and mentions of them in the media. This provides the user with a fuller set of information about a contact, which can help the user build a better context in which to communicate with the contact.

When a user visits a webpage, such as the profile page of a contact on a social networking site, the present invention determines the topic of the page to be the contact. Through an examination of the private social graph described above, the contact corresponding to the determined topic can be selected. The information about this contact is then selected as the extrinsic metadata to be displayed. As an example, when a user views the profile page of a contact on a first social network, the present invention will determine that the topic of the page is the contact, and will select the contact's information from the private social graph. The social networks on which the user is connected to the contact are then mined to provide a status indication in a sidebar. Each indicator can be provided as a link allowing the user to click on the status indicator and be brought directly to the corresponding profile page. The stored address book information, the last email message to the user, an instant messenger history and other such information can be provided as well. Contacts common between the user and the contact can also be displayed.

The analysis of a webpage to determine which contact in a social graph is the topic of a page need not be limited to social networking sites. If the user makes use of a web-based email client, while reviewing or composing email messages, the sidebar can be updated to display information about the sender/recipient of an email message by linking the from:/to: email address to a connection in the private social graph. Thus, when a user receives and views an email message, the known information about the sender is presented to the user in a sidebar. Similarly, when a user composes an email message to a contact, the sidebar can be updated to reflect the known information about the intended recipient. To determine the contact associated with the message, the present invention can analyze the content of the webpage using a known template to determine the relevant information.

By displaying this information about a connection, the user can be provided the opportunity to open other profile pages, read a blog, create a connection to the person on a social network that they are not connected through, or any number of other connection-centric activities.

The analysis of received webpages to determine a topic so that extrinsic metadata can be displayed can be extended to provide the user other useful information. For example, if a user visits a corporation's website, the sidebar can determine which connections in the social graph are associated with that corporation, for example by determining who is a present or past employee of the company. This can be done in a number of ways including extracting employment information from social networking sites, or by an analysis of the email addresses associated with connections in the social graph and comparing the domain of those email addresses to the domain of the website. This could also be used to provide a list of connections to a company when the company is referred to in an article.

As noted earlier, information extracted from a social graph is simply one of the many types of extrinsic data that can be employed by the present invention. Before displaying extrinsic metadata about a webpage, the present invention must first determine the topic of the displayed webpage. The topic of the webpage can be determined from an analysis of the URL of the webpage, or an analysis of the page itself.

Many webpages are structured to allow a programmatic analysis of the page. This structure is typically consistent across the hosting domain. In one example, webpages containing reviews of a product on a given site are typically organized to identify the subject of the review in a consistent manner. In another example, a social networking site often identifies the user associated with a profile page in the URL or in a specified field on the page. This consistency allows for a programmatic analysis to determine the topic of a page. In embodiments where the determination of the topic of a page is done on the client side, the determination of a topic from a page can be implemented by creating an analysis engine that will work across different domains. Different sites may require different techniques including analysis of the URL, analysis of a topic tag, analysis of outbound links, analysis of the page content and other such techniques. Some sites will require only one technique, while others will require a combination of the techniques. It is conceivable that on some sites, certain techniques should be avoided in favor of other techniques to avoid obtaining errant results. To allow a client side topic determination, the present invention can retrieve a set of cues from a central repository indicating which procedural and programmatic techniques should be applied to a page to determine the topic. In one embodiment, a webpage is retrieved and a set of cues to facilitate the determination of the topic of the page is retrieved from a central repository. The retrieved cues can contain scripts or can identify routines already stored at the client side for doing various types of processing for a given domain such as: retrieving data from the site using an API, formatting of data retrieved by an API or RSS feed for display in the context bar, code to update the status on the site, code to retrieve a profile photo from the site. By making use of centralized cues that are retrieved during the topic determination, the user can be constantly provided the most up-to-date topic determination techniques associated with a page. Some cues can be specific to all pages in a given domain, while other cues can be specific to pages in a particular sub-domain so that variations across related sites can be accommodated. This can be of particular benefit where a site has different localized versions of its content using different layout and formatting for different geographic regions.

The cues retrieved from the central repository can assist in determining which parts of a page provide corporate name information, which parts of the page identify a particular product (such as in a review of a product), and which parts of a page identify individuals. Additionally, when a product is reviewed, a person discussed, a news story presented and in many other cases, a link is provided to another page that is solely related to the topic. Examples of this include the inclusion of a link to a product page on a manufacturer website in reviews, and links to profile pages or news stories in commentaries about people or a particular. The identification of an embedded URL can be used to identify the topic of a page in cooperation with other information. The cues used to assist the topic discovery can be based on the URL of the page, a portion of the URL, or on an embedded URL. Thus, for example, a site that specializes in reviews of new products may use a template associated with all pages under a certain branch of a domain. Cues specific to this template can be either locally stored, or centrally stored and accessed during the page view. By centrally storing the cues, updates to the cues can be performed once, and the propagation of the change is effectively immediate. These cues can be centrally administered, but in one embodiment the creation of the cues can be distributed to the users of the browser who can create templates as they view webpages.

One skilled in the art will appreciate that the extraction of a topic from a webpage can be viewed as a generic function that has a site specific implementation. This generic function can be one of a set of functions provided by an API, where the specific implementation of the function is handled differently for each site. For other sites, such as social networking sites, the generic functions can be extended to include bi-directional generic functions such as obtaining a list of contacts, obtaining information about the contacts, obtaining the status of contacts, setting the status of the user, obtaining a profile photo of a contact, uploading a profile photo for the user's profile and other such functions. Other functionality including the retrieval of data from a feed such as an RSS feed can be implemented through the API to allow specific formatting of a received feed in accordance with user preferences. The creation of an API to allow generic functions to be accessed by a client, with site specific implementations, can be provided in such a manner that the functionality accessible to the client is defined from the central repository, which allows new features to be sent to the client automatically. If a particular site modifies the manner in which a particular function is handled, the site specific implementation can be modified without changing the API, allowing the update to be transparent to the user.

As a refinement on the topic discovery method, a list of both inbound and outbound links can be employed to assist topic discovery. Knowledge of which pages link to a given page can be extracted from a webpage crawl done by search engines. The manner in which one page links to another can be a good indicator of the topic of the page.

By being able to identify the topic of a webpage, content related to that topic can be displayed in the sidebar. For example, when viewing a product review, extrinsic metadata associated with that product can be displayed in the sidebar. If a social graph connection has reviewed the product on a vendor site, a link to the review can be provided. Contacts who have been identified as having the product can be listed as owners, and links to vendors selling the product can also be provided. These links can be provided as a service to the user, and can be an opportunity for revenue generation.

Users have become wary of Internet advertising in general, but are often receptive to contextual information such as recommendations for related products (e.g. Amazon.com recommendations and Google AdWords) that are presented in an unobtrusive manner and that relate to the current activity.

To provide contextual information to the user, including both social networking information and contextual advertising, the present invention determines the topic of a webpage, selects information relevant to the topic (extrinsic metadata), and then presents the selected information in a preferably unobtrusive manner.

Determining the topic of a webpage can be difficult, as some pages may contain information that relates to more than one topic. The URL of the webpage, or a fragment of the URL, can be used as a unique identifier of the webpage. The domain of the page alone may be sufficient to identify the page as a personal blog, or a corporation's website. If this is the case, the domain alone can be used to select information for display. If the domain indicates that the user is viewing the blog of someone in the social graph, the connection information can be displayed, including a list of recent correspondence with the blogger, a list of status updates from various social networking sites and an indication that there are social networking sites through which no connection has been made. If it is a corporate website, a list of connections in the social graph that work for the site can be displayed as can any RSS feeds associated with the company.

If the URL is associated with a social networking site, the domain and a URL fragment is typically sufficient to identify the person associated with the profile page being viewed. Based on this identification of the topic as a person, the social graph can be examined to identify connections to the person, and the connection-centric view of the person referred to above can be displayed.

Identification of the topic of a page as a person can also be a result of determining that for pages associated with a domain, the content of the page can be parsed in a known manner to identify the topic of the page as a person. Examples of such sites include social networking sites that do not use URL based identifiers and webmail and online address book services.

To identify a product as a topic of a page, the URL of a page containing a product review may contain identification of the product, or the page will be formatted in a defined manner to readily provide the topic in a predicted location.

Thus to identify the topic of a page, the URL of the page is examined. The URL is first parsed to identify the domain. Domain specific rules can then be applied. Typically across an entire domain either a URL based parsing can be used, or a page based parsing can be used. In some instances, it may be required that the URL be parsed, and if no information is found, the page can then be parsed. The determination of which mechanism to use can be stored in the aforementioned template so that the user is provided with this experience quickly. As discussed earlier, outbound URLs can also be used as topic identifiers on such pages.

When a website changes the manner in which their content is organized, it may result in the need to modify the template. With centralized templates, there is no need to propagate the modifications to each subscriber, and instead the user is automatically provided the new template the next time they visit that website.

Based on the URL, the topic can be identified, and can also be classified. The classification of the topic, along with the identification is then used in the selection of the content for display. Topics can be classified as, among other things, a person, a company, a product or service, a destination, a news story, and an event. Topics in different classifications can be treated in different ways. Whereas for a person a social graph search may be performed, a corporation may result in both a social graph search to identify people associated with the company and a search of news feeds for information about the company. A product or service can result in a search for reviews of the product or service in question authored by connections in the social graph, along with suggestions for where to buy the product, or for alternative products. If a geographic location is the topic, the user can be presented with contextually relevant information including travel and hotel information if the location is distant from the user, and other contextual information such as a list of activities if the location is local. A list of connections near the geographic destination can be provided, as can a list of people who plan to be traveling to that location if such information can be extracted the social network.

When the topic is identified as a news story a list of related stories from RSS feeds can be provided, as can a list of connections in the social graph who have recommended the story. If the topic is an event, the information about the connections who will be attending the event can be included, as can a list of advertisements for gifts that may be relevant to the event.

To select the contextually relevant extrinsic metadata, a number of data sources can be consulted. Contextually relevant information about people can be obtained through analysis of the social graph, the associated social networking sites. The social networking connections to the person, or lack thereof, can be displayed along with whatever other information can be obtained through address book entries, email and IM histories and other connection logs. If a person is not connected through the user's social graph, it may be possible to indicate that a connection through a contact in the socials graph is possible. This can be determined through an analysis of the connections of each connection in the social graph. Data about people can be obtained through public references, partnerships and if the present invention has access to social networking sites on behalf of the user, through privately available information.

Displaying the information in an unobtrusive manner can be done in a number of ways. In one embodiment, a sidebar is displayed beside the browser window. When there is data to be displayed it is shown in the sidebar. The user can be provided the option of hiding the sidebar. If the sidebar is hidden, the user can be notified of the availability of information through the use of various notifiers including a notification bar, a temporary display window such as a Growl™ notification, and an icon indicating that contextual information is available. If the user leaves the sidebar on the screen at all times, it can be used to display email arrival alerts, status updates from social networking connection, RSS feed updates and user defined information. This encourages the user to leave the sidebar in place so that when contextually relevant advertisement is available, it is displayed to the user.

Users can be provided the ability to indicate whether the displayed information is relevant. This relevance information can then be stored to adjust the selection of contextual information. Aggregated relevance information can be provided to a centralized repository so that the linking of contextual information to an identified topic can be adjusted to provide all users an enhanced experience.

Based on information known about the user, from a variety of sources including the browsing history, conversation history, social network profile data, bookmarked sites and local profile data, modification to the selected contextually relevant data can be made. Thus, when a location is the topic of the page, the present invention can determine if the location is local or distant. It is unlikely that the user is interested in hotel or travel information to a local location, but it is likely that it is useful if the location is distant. Similarly, advertising information providing links to locations at which a user can buy a product can be adjusted based on the location of the user. Those skilled in the art will appreciate that other accessible identity information can be used to refine the contextually relevant information selected in various ways.

When a user is presented with a connection centric view of a person through the present invention, she may be provided the opportunity to connect to the user on a social network that they are not connected over. When the user indicates that they would like to make such a connection, the present invention can insert text into a message to the person indicating how the person is connected to the user. Similarly, the inserted text can include a link advertising the fact that an embodiment of the present invention was employed. This provides a viral marketing of embodiments of the product.

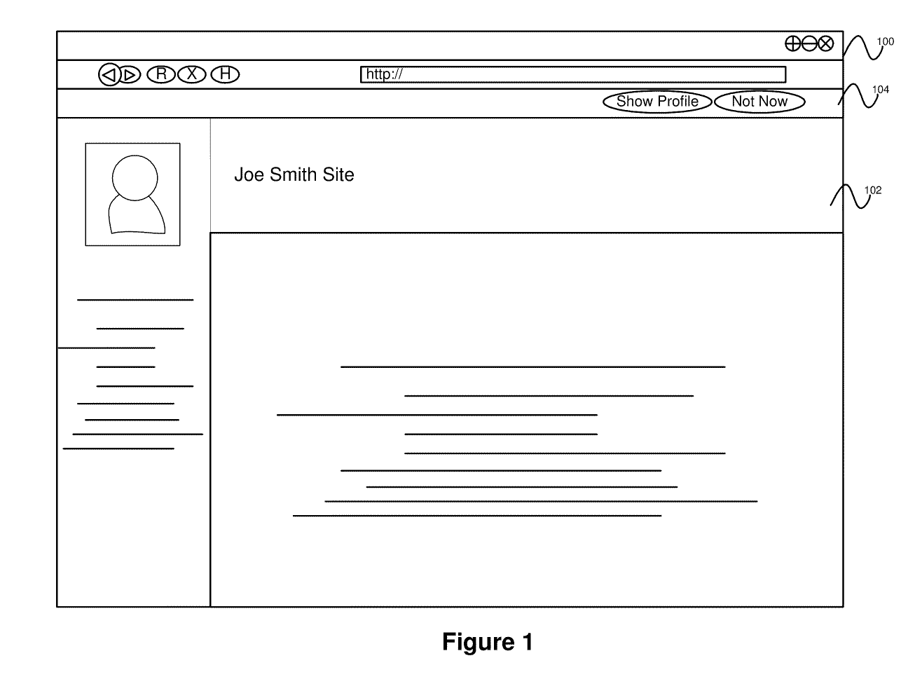

FIGS. 1-12 illustrate the operation of the method and system of the present invention. One skilled in the art will appreciate that the method and system of the present invention can be implemented as a web browser plugin, a web browser extension, as a portion of an integrated context sensitive browser, or in any of a number of other embodiments. The functional design of the present invention will be apparent to those skilled in the art.

In FIG. 1, a user directs the browser 100 to a website 102, which when retrieved is associated with a contact for whom profile information is available. The extrinsic metadata display can be hidden by the user if they do not want a cluttered display. When extrinsic metadata, such as user profile information is available, and the display is not shown, the browser can prompt the user to open the display. In this embodiment a bar 104 at the top of the screen is presented allowing the user to click on the circled button to invoke the extrinsic metadata display, which will be presented as a sidebar. In the following discussion, a control that is illustrated with a circle on it indicates the control that the user will click on to bring up the screen illustrated in the next figure.

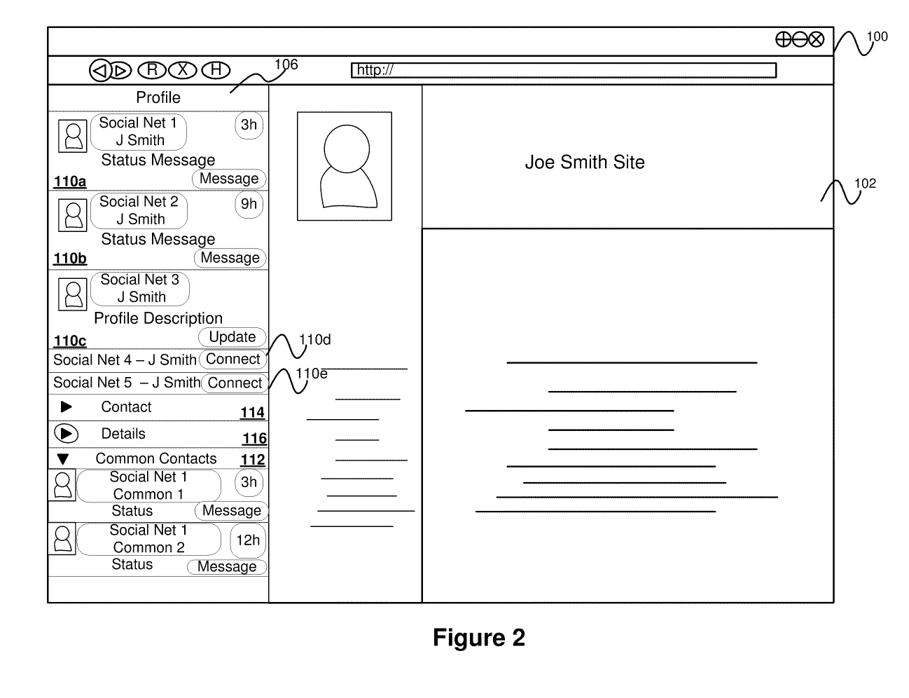

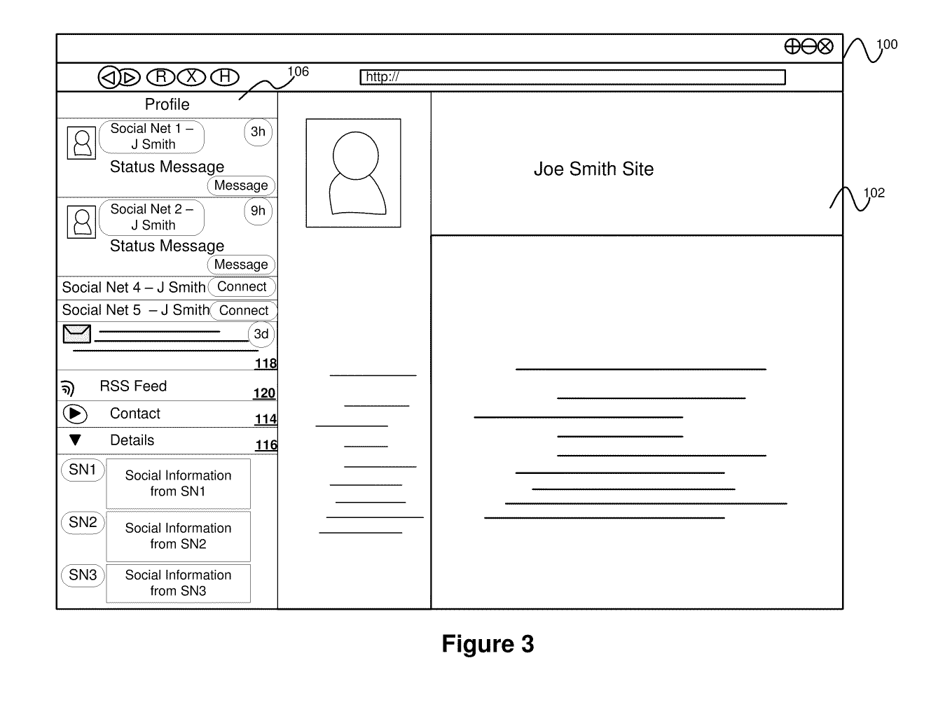

FIGS. 2 and 3 show the extrinsic metadata display as a sidebar 106. The topic of the displayed webpage 102 was a contact for whom extrinsic metadata is available in the form of profile data 108. The social networking profile data 110a-c is presented in the sidebar 106. The sidebar 106 illustrates the various social networks that the user is connected to the contact through, and also shows two social networks that the user belongs to but over which no connection to the contact has been made 110d,e. If there are social networks to which the user belongs, but on which the contact cannot be identified, the user can be provided the ability to invite the contact to join them on the social network instead of simply connecting to the user. Each of the status boxes for a contact in the sidebar that relates to a social networking site can provide the user with a status and the length of time since the status was updated. These status boxes110a-e can act as links that will direct the browser 100 to the profile page of the contact on the respective social network. The user can also access an address book entry for the contact 114, and see the last email correspondence with the contact 118 along with an RSS feed 120 associated with the contact. Contacts common to both the user and the contact 112 that is the subject of the displayed webpage can also be displayed. The user can collapse various displays including a contact information pane 114, a details pane 116 and the common contacts pane 112. The user can expand the collapsed Details pane by clicking on it as indicated.

Specifically, FIG. 3 illustrates the result of expanding the Details pane 116 in the sidebar 106. The connection details obtained from different profile data sources is displayed, along with the source of the connection details. This allows a user to quickly discern information about the contact that may not be available in locally stored data. The user can click on the Contact pane 114 as indicated to expand it.

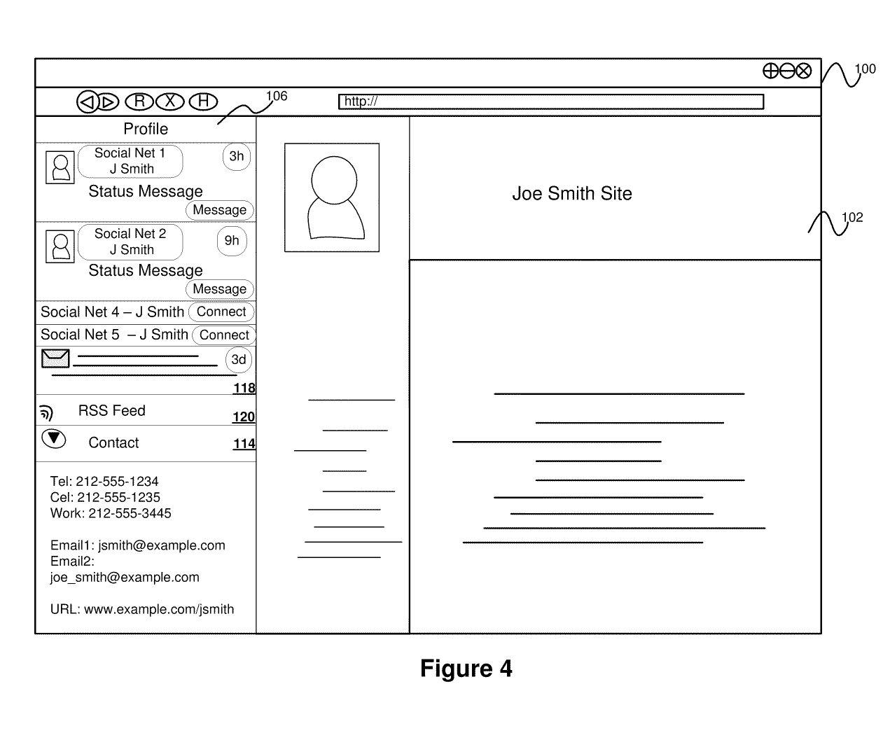

FIG. 4 illustrates the result of expanding the contact pane 114. Contact information for the user is displayed. In one embodiment, this information can be obtained from private sources such as the address book (which may or may not be locally stored). One skilled in the art will appreciate that the contact information can be obtained both from the data available through the socials networks and stored into the address book. After viewing the information in the contact pane, the user can collapse the pane by clicking on the control as indicated.

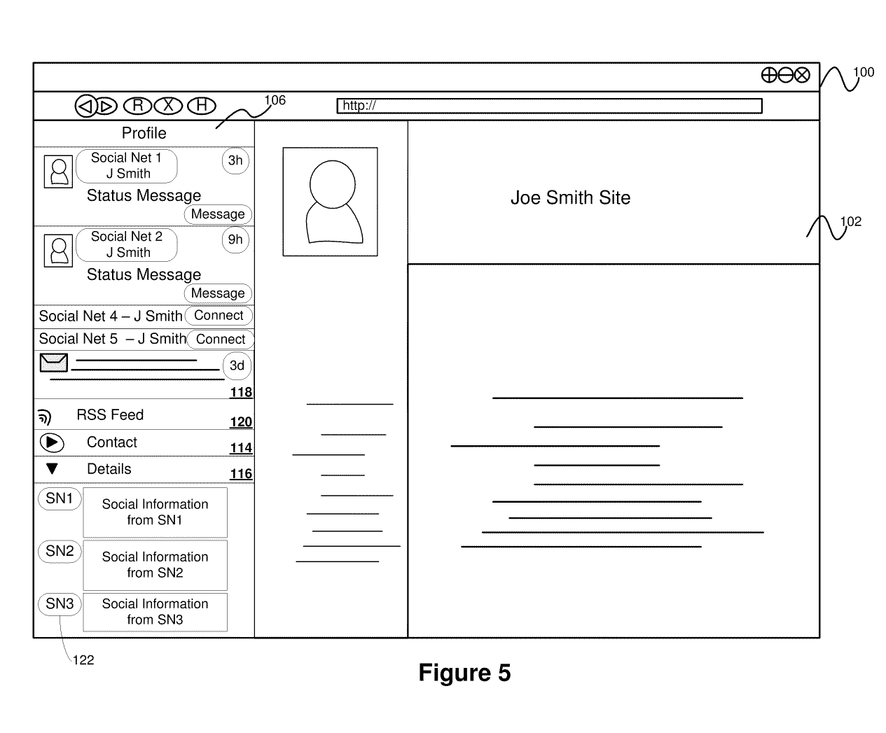

FIG. 5 illustrates that the result of collapsing the contact pane 114 is that the sidebar returns to its state as illustrated in FIG. 3. The user can now click on either a profile box 110a-e, or a social network icon 122 in the Details pane 116 as indicated.

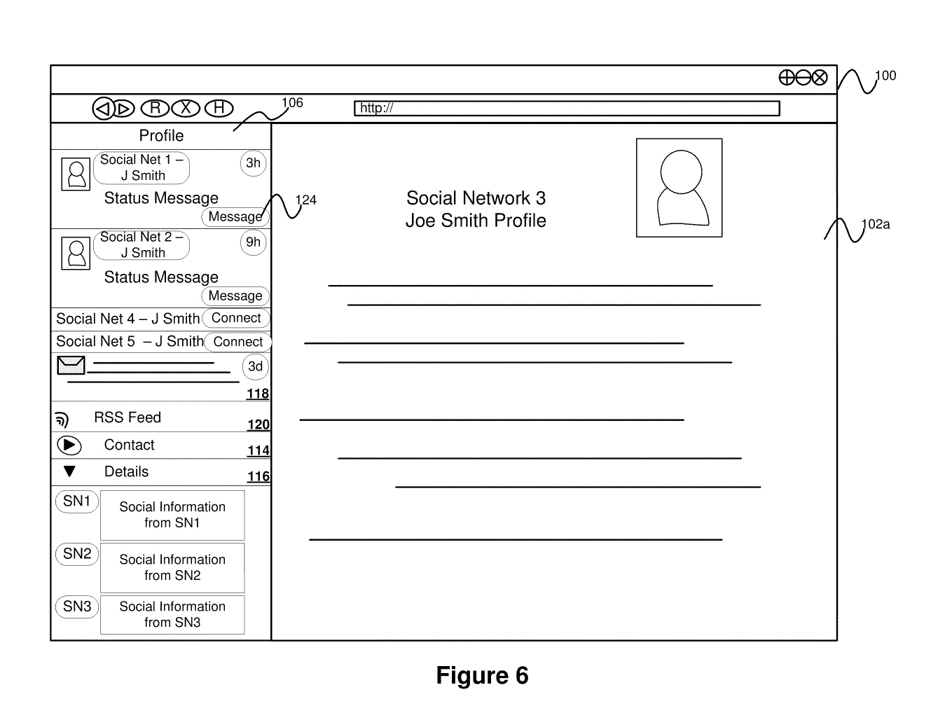

Clicking on the social network icon 122 in the Details pane 116 of FIG. 5 will direct the browser 100 to the profile page 102a of the relevant social network as illustrated in FIG. 6. One skilled in the art will appreciate that although FIG. 6 illustrates this action as directing the existing browser to navigate to the social networking site in the default window, a new browser window can be created, or a new pane in the browser can be used. The manner in which following a link is handled in the present invention can be set as user preference as will be understood by those skilled in the art. The user can also interact with contacts through the social networks without being required to go to the social networking site first. If a user wishes to send a message to a contact on a network that they are connected over, and the network supports user messaging, the user can click on the Message portion 124 of the status box 110a, as indicated.

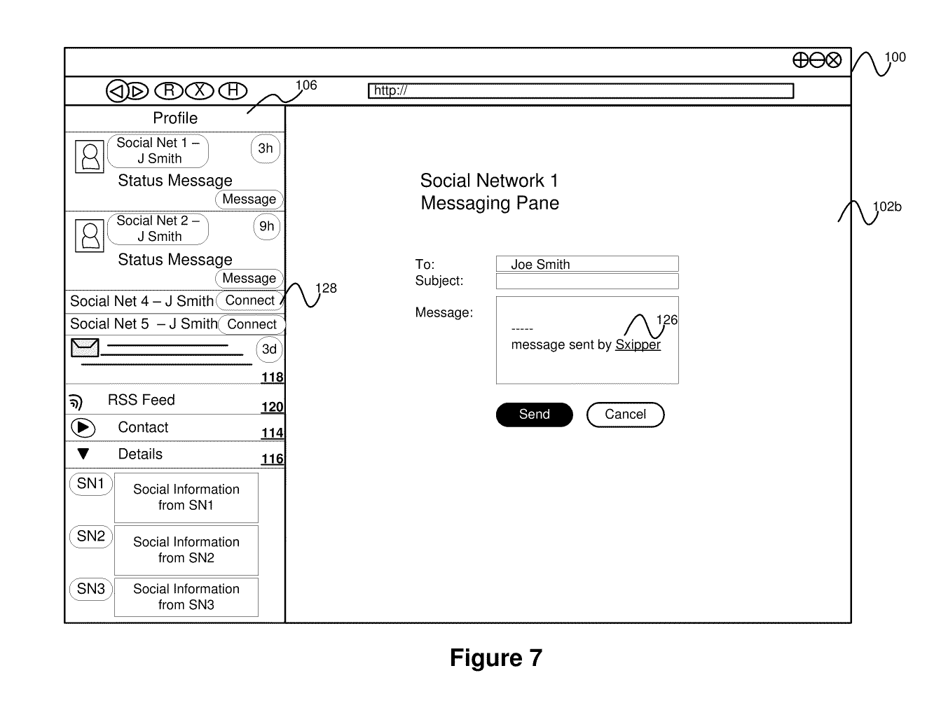

FIG. 7 illustrates that the user can click on the Message link 124 in FIG. 6. When the user activates this control, the browser 100 is directly sent to the messaging page of the social networking site 102b, and a message to the contact is created. In a presently preferred embodiment, the message will include a short message 126 advertising its service to promote viral adoption of the extrinsic metadata display. If a user is not connected to the contact on a particular social network that they are both members of, the option to connect to the contact can be provided. As indicated, to connect to the contact, the user can click on the Connect control 128.

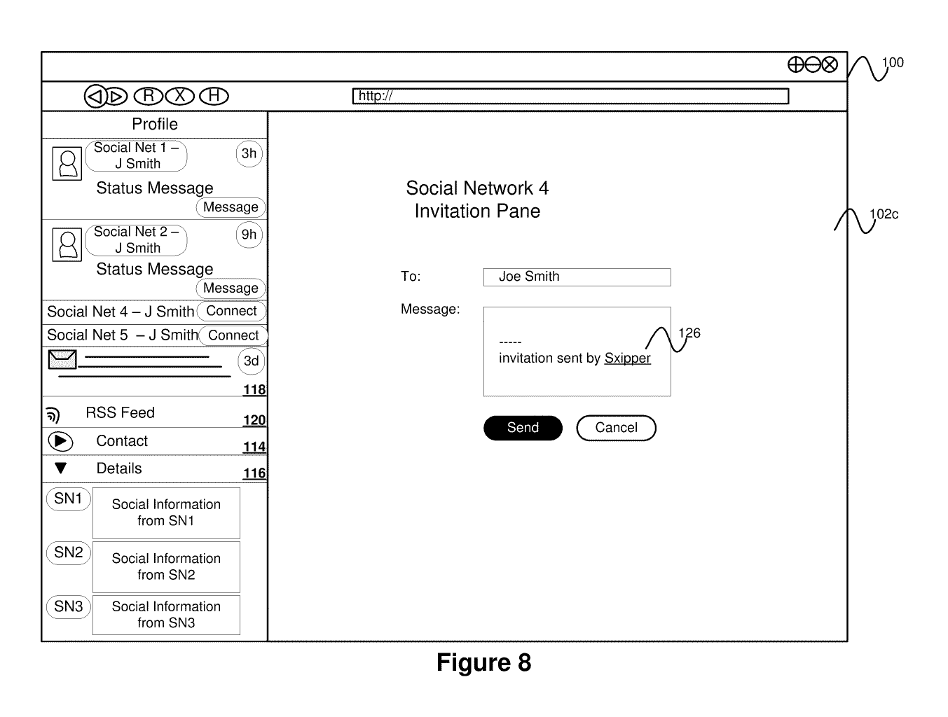

Clicking on the connect control 128 in FIG. 7 causes the browser 100 to load the relevant page 102c on the social network to allow the user to connect to the contact as illustrated in FIG. 8. As before, a tag line 126 can be added to the invitation message to allow viral marketing.

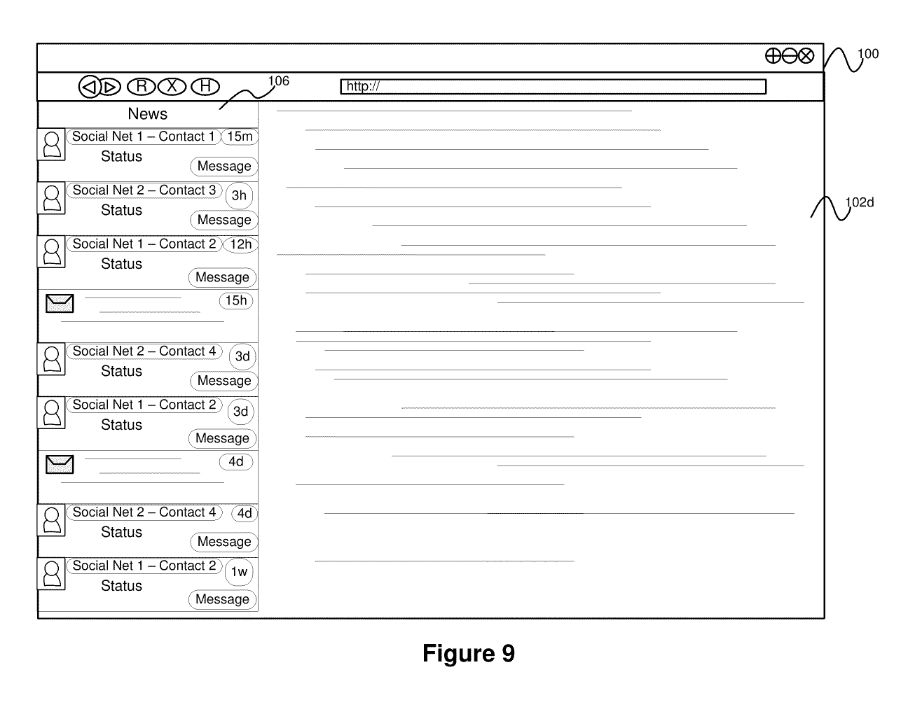

When the user loads a page 102d in the browser 100 for which there is no relevant extrinsic metadata, the sidebar 106 can be used to show contact activity as illustrated in FIG. 9. The contact profile boxes for various social networks are displayed and are sorted in chronological order, so that the most recent updates from any contact are put at the top of the sidebar. Thus a single contact may appear a number of different times in the sidebar, but the appearance of status information from that contact is placed in the sidebar in the order in which the status updated occurred. This allows the user to easily see status changes among contacts. This configuration of the status bar 106 can be thought of as a multi-network feed of contact status messages.

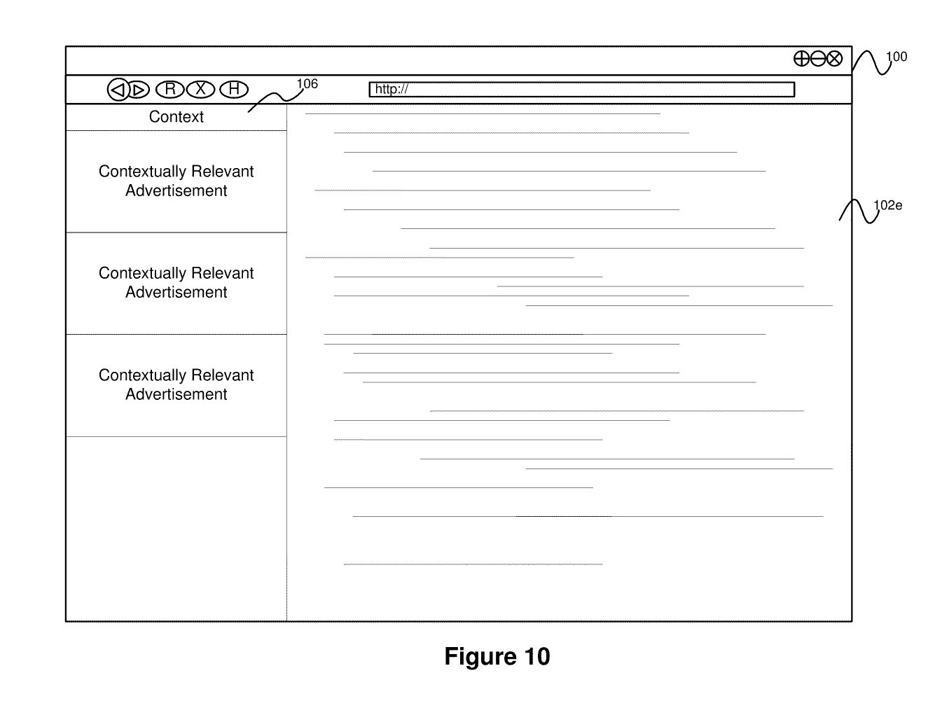

In FIG. 10 the user has directed the web browser 100 to a page 102f that has a topic for which extrinsic metadata is available. The topic is not related to a person, and instead is related to a product. Advertising 130 relevant to the product is displayed in the sidebar to allow the user to obtain other information. The sidebar 106 can also contain links to other reviews, or blog postings by contacts on the determined topic. This provides the user with contextual information about the topic of the page in the sidebar.

Those skilled in the art will appreciate that the particular interfaces illustrated in the figures are exemplary in nature and should not be construed as limiting to the scope of the present invention. Other interfaces can be employed, and additional features can be added based on designer or user preference.

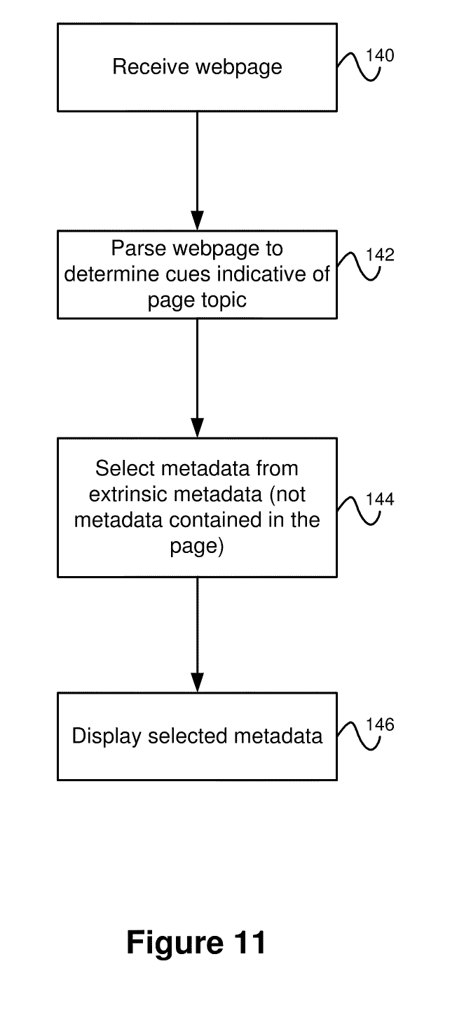

FIG. 11 illustrates an exemplary method of the present invention. One skilled in the art will appreciate that minor modifications to this method can be undertaken without departing from the scope of the present invention. Use of this method can enable functionality such as that disclosed above. In step 140, a browser receives a webpage. This webpage is parsed in step 142 to identify cues indicative of the topic of the received webpage. One skilled in the art will appreciate that as disclosed above, various topic identification methods can be employed. Extrinsic metadata is selected 144 based on the identified topic. As opposed to prior art solutions that determine relevant metadata for page content based on a common pool of information for all users, the present invention employs a pool of data that at least a portion of is specific to the user. This portion of the data can be drawn from local content such as address book and email application information, or through online content such as online email, address book and social networking information obtained through the aforementioned social graph. The selected information is then displayed 146 to the user through an interface, such as the sidebar embodiment discussed above.

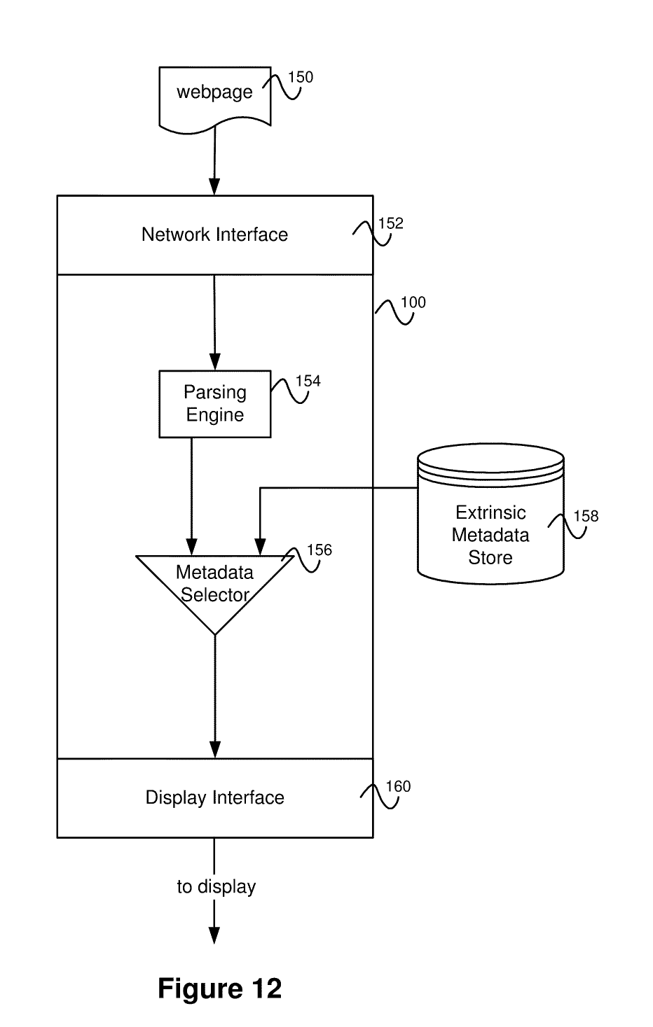

FIG. 12 illustrates an exemplary embodiment of a system of the present invention. Browser 100 receives a webpage 150 through a network interface 152. Network interface 152 can be embodied in a conventional hardware interface administered through software or firmware. A parsing engine 154 examines the received webpage to determine cues indicative of the topic of the webpage. The method disclosed above for identifying the cues can be implemented in some embodiments of the present invention as software executed on a general purpose processor, or on a specially designed processor. The identified cues are provided to the metadata selector 156 which, based on the cues, selects metadata from the extrinsic metadata store 158. The selected metadata is then routed to the display interface 160 so that it can be displayed to the user.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of selecting extrinsic metadata relevant to a user about a webpage comprising:
receiving a webpage from an external server through a network interface;
parsing the received webpage to identify cues indicating the topic of the webpage;
selecting metadata from an extrinsic metadata store in accordance with the identified cues, at least a portion of the metadata in the extrinsic metadata store being specific to the user; and
displaying the selected metadata to the user through a display interface.

2. The method of claim 1 wherein the step of parsing the received webpage includes examining at least a portion of the uniform resource locator associated with the webpage.

3. The method of claim 2 wherein the step of parsing the received webpage further includes comparing the examined portion of the uniform resource locator to a social graph.

4. The method of claim 2 wherein the step of parsing further includes comparing the received webpage to a template selected in accordance with the examined portion of the uniform resource locator.

5. The method of claim 1 wherein the step of parsing the received webpage includes examining the received webpage for intrinsic metadata to identify cues.

6. The method of claim 1 wherein the step of parsing the received webpage includes examining outbound links.

7. The method of claim 1 wherein the step of parsing the received webpage includes examining the received webpage for personal identifying information.

8. The method of claim 7 wherein the personal identifying information is selected from a list including: email addresses, phone numbers, and instant messenger identifiers

9. The method of claim 1 wherein the step of selecting metadata includes selecting at least one of contact information stored in an address book associated with the user, social networking information available through social networking sites accessible to the user, email messages stored in archives associated with the user and, a search engine accessible to the user.

10. The method of claim 1 wherein the topic is one of a person, a company, a location and a news story.

11. The method of claim 10 wherein the topic is a person and the step of selecting metadata includes selecting contact information obtained from a locally accessible address book, email messages stored in archives associated with the user, and social networking information available through social networking sites accessible to the user.

12. The method of claim 10 wherein the topic is a company and the step of selecting metadata includes selecting contact information, social networking information and email messages associated with individuals associated with the company obtained from the extrinsic metadata store.

13. The method of claim 10 wherein the topic is a location and the step of selecting metadata includes selecting contact information and social networking information associated with contacts of the user who are geographically proximate to the location, weather information, hotel and transit availability and news stories relevant to the determined location.

14. The method of claim 10 wherein the topic is determined to be a combination of two or more individual topics.

15. The method of claim 1 wherein the step of displaying the selected metadata includes alerting the user to the existence of the selected metadata.

16. The method of claim 1 wherein the step of displaying the selected metadata includes displaying the metadata in a sidebar.

17. The method of claim 16 wherein the step of displaying the selected metadata includes displaying different types of metadata in boxes in the sidebar.

18. The method of claim 17 wherein the boxes displayed in the sidebar can be collapsible and can contain hyperlinked data.

19. A browser for displaying extrinsic metadata about a webpage, the browser comprising:
a network interface for receiving webpages from external servers;
a parsing engine for examining webpages received by the network interface and for identifying cues indicating the topic of the examined webpage;
a metadata selector for selecting data from an extrinsic metadata store in accordance with the topic indicated by the cues identified by the parsing engine; and
a display interface for transmitting the selected data to a user viewable display.
